(19) United States
(12) Patent Application Publication
(10) Pub. No.: US 2013/0052631 A1
(43) Pub. Date: Feb. 28, 2013

(54) CUSTOMIZABLE ELECTRONIC SYSTEM FOR EDUCATION

(71) Applicants: Shankar Moni, Bangalore (IN); Sheloney Moni, Bangalore (IN)

(72) Inventors: Shankar Moni, Bangalore (IN); Sheloney Moni, Bangalore (IN)

(73) Assignee: MOODEYE MEDIA AND TECHNOLOGIES PVT LTD, Bangalore (IN)

(21) Appl. No.: 13/695,382

(22) PCT Filed: Apr. 5, 2011
(86) PCT No.: PCT/IN11/00311

§ 371 Date: Oct. 30, 2012

(30) Foreign Application Priority Data
May 4, 2010 (IN) 1246/CHE/2010
May 4, 2011 (IN) PCT/IN2011/000311

(51) Int. Cl. G09B 7/00

(52) U.S. Cl. 434/362

(57) ABSTRACT

A customizable electronic system for education that includes a processor (202) to process an audio, and a video, a memory (218) to store a personal information and a performance data of one or more user, a video formatting chip (224) that formats the video output from the processor, an audio formatting chip (226) that formats the audio output from the processor. The processor executes an educational method that includes processing a login information corresponding to the user, displaying a list of options that includes taking a session, executing at least one session based on a user input that includes selecting the option of taking the session, processing a first answer to the one or more question, generating any of an audio or a visual feedback automatically on submitting the answer based on an accuracy of the answer.

### BACKGROUND

1. Technical Field

The embodiments herein generally relate to electronic devices for education, and, more particularly, to a hardware electronic system and a software framework optimized for the hardware system for education.

2. Description of the Related Art

Computers and the internet are being increasingly used for education. They enable storage of educational material electronically and interaction with speed unlike traditional workbooks, text books etc. Various software applications are available on the internet as well as on CD-ROMS that can be executed on general purpose PCs. These software applications can be used by users to practice problems (e.g., in math). However these problems are typically pre-created and they have pre-determined answers. Whereas a user can practice a set of problems on a CD-ROM or on a worksheet downloaded from the internet, once the problem set is completed and the answers are graded, the solutions become known. Thereon, practicing the same pre-determined problem set again may only lead to rote learning of the answers by memory, instead of encouraging application of the user's mind in new ways. Further, content on CD-ROMs can be copied (e.g., pirated).

Personal computers and the internet are still not easily accessible to all users at their homes, as much as televisions are, particularly in developing countries. Personal computers have various expensive components such as LCD monitors, hard drives with high storage capacities, CD-ROM drives, and high speed processors that can support a wide range of applications including gaming. Most PCs today come along with all the above mentioned features that are not really required for education related applications. PCs also consume a lot of power. A personal computer (PC) is typically used by multiple users in a family for various purposes. A child, when allowed to use a parent's computer may potentially disrupt settings and possibly even erase valuable data. Moreover, a child can end up getting easily distracted while operating a PC by various other applications such as games or by surfing non-education related websites.

Depending on a level of ability in a particular subject, different students may require different amounts of practice to learn a particular topic. In a regular classroom environment, all students are treated equally and given equal amounts of practice and exposure. This is a disadvantage for students who require more practice. Further, to provide additional practice to students, teachers have to design problems with different variables to keep the students stimulated and to discourage rote memory. Designing new problems, particularly keeping certain physical constraints can be challenging for teachers, who may not be adequately trained to create and design new problems, although they are trained to solve such problems.

### SUMMARY

In view of the foregoing, an embodiment herein provides a customizable electronic system for education. The customizable electronic system for education includes a processor to process an audio, and a video, a memory to store a personal information and a performance data of one or more one user, a video formatting chip that formats the video output from the processor, an audio formatting chip that formats the audio output the processor. The processor executes an educational method that includes processing a login information corresponding to the user, displaying a list of options that includes taking a session, executing one or more one session based on a user input that includes selecting the option of taking the session. The session includes one or more question that is displayed on a question screen. The educational method further includes processing a first answer to the one or more one question on the question screen, generating any of an audio or a visual feedback automatically on submitting the answer based on an accuracy of the answer and processing one or more one additional answer attempted to the question if the first answer is determined to be incorrect. The list of options further includes practice with an automatic selection, practice with a user selection, and a review or a rework of the session. The educational method further includes displaying a progress report based on a performance of the user on a plurality of the sessions. The review or the rework of the list of options has same or different values of one or more one variable in the question. The correct answer of the question is dependent on a value of the variable.

The educational method further includes displaying a correct answer adjacent to the answer that is submitted when the answer does not correspond to a correct answer, customizing the session based on the performance of the user and enabling the user to attempt higher level questions once the performance of the user is determined to be consistent.

In another aspect, a customizable electronic learning system is provided. The customizable electronic learning system includes a user database that includes any of a past session information, a personal information and a performance information, a curriculum database that includes a hierarchical curriculum data corresponding to a course, a syllabus, or an examination, a level setting module that executes a plurality of sessions based on the curriculum data and a performance and level of the user. Each of the sessions includes one or more one question that includes one or more one variable displayed on a question screen. The correct answer of the question is dependent on a value of the variable and a randomization module that randomizes values of the variable at different instances of the sessions being executed.

The randomization is subject to one or more of a mathematical constraint that limits the number of acceptable values of the variable. The customisable electronic learning system further includes a feedback module that generates an audio or a visual feedback based on a performance of the user in the session. The audio or the visual feedback includes any of an image corresponding to a likes of the user, a stars, a medals, a congratulatory sound, and a music. The customizable electronic learning system further includes a topic selection module that allows the user to select a session type. The topic selection module further includes a session type selector and a list of permitted topics.

The session type selector further includes an automatically generated topic-set from which the user selects a set of topics, a user-selected topic-set, a session on a chosen set of topics, the session having a timeout after which the processor disables input to the system, a rework of earlier performed question sets with either identical or re-randomized numbers and a homework session that is a predefined set of randomized questions.

The customizable electronic learning system further includes a hardware constraint module that specifies a plurality of hardware constraints and permits the system to be customized based on hardware constraints, a user preference module that allows the user to choose a curriculum based plurality of questions, to set a duration, settings and level based on output by the consistency module and a customization module that customizes the system based on the user's personal information stored in the user database.

The customisable electronic learning system further includes a consistency module that measures a consistency with which the user performs in the session. The consistency is measured on a performance history and a plurality of the sessions attempted and a duration required by the user to attempt the sessions.

The customisable electronic learning system further includes a customization module that enables customization of the question screen based on the personal information, a curriculum creation module that extracts a subset of the curriculum that is relevant for a particular career and creates a curriculum that is sufficient prerequisite to pursue the career, a question template selection module that selects question templates from the curriculum database. The question templates are selected based on a level appropriate for the user which is based on feedback from the level-setting module. The customized learning system further includes a question creation module that integrates a plurality of questions selected by the question-template selection module with a randomization provided by the randomization module and the customization provided by the customization module and generates a composite question with appropriately customized text, numerical values, colors, images and themes. The customisable electronic learning system further includes a performance tracking module that communicates short term and long term performance of the user to the feedback module and to the user database.

In yet another aspect, a customizable electronic learning system is provided. The customizable electronic learning system includes a user database that includes one or more one of any of a personal information, a performance information or a past session information of one or more one user, a curriculum database that includes a hierarchical curriculum data corresponding to a course or a syllabus, a consistency module that measure a consistency with which the user performs in one or more one session. The consistency is measured on a performance history, a plurality of the sessions attempted and a duration required by the user to attempt the sessions and a customization module that enables customization of a question screen based on the personal information. The customization includes any of a personalization of one or more one question in the session and a personalization of a background of the question screen. The customisable electronic learning system further includes a feedback module that generates an audio or video feedback on a performance of the user in the session,

The personal information includes any of a name, a gender, an age, a likes, a dislikes, a friends, or an enemies. The question is a word problem and the personalization of the question includes a question theme based on the personal information. The personalization of the background includes a personalized images or a personalized multimedia. The customisable electronic learning system further includes a performance tracking module that communicates short term and long term performance of the user to the feedback module and to the user database and an answer evaluation module that evaluates answers of the user based on constrained randomization in the questions and renders correct answer adjacent to the answer of the user in case the answer is incorrect.

In yet another aspect, a customizable electronic learning system is provided. The customizable electronic learning system includes a user database that includes one or more one of any of a personal information, a performance information or a past session information of one or more one user, a curriculum database that includes a hierarchical curriculum data corresponding to a course or a syllabus, a customization module that enables customization of a question screen based on the personal information. The customization includes any of a personalization of one or more one question in the session and a personalization of a background of the question screen. The personal information includes any of a name, a gender, an age, a likes, a dislikes, a friends, or an enemies. The personalization of the background includes a personalized images or a personalized multimedia. The electronic learning system further includes a hardware constraints module that specifies hardware constraints and allows the system to be customised based on hardware constraints, a randomization module that randomizes values of the variables at different instances of the sessions being executed.

In yet another aspect, a customizable electronic learning system is provided. The customizable learning system includes a user database that includes one or more one of any of a personal information, a performance information or a past session information of one or more one user, a curriculum database that includes a hierarchical curriculum data corresponding to a course or a syllabus, a question creation module that integrates a plurality of questions selected by the question-template selection module with a randomization and a customization and generates a composite question with appropriately customized text, numerical values, colors, images and themes, performance tracking module that tracks a plurality of session attempted, score and a duration required and a feedback module that generates an audio or image feedback based on a performance of the user in the session. The audio or image feedback includes stars, medals and music. The customizable electronic learning system further includes a curriculum creation module that extracts a subset of the curriculum that is relevant to a particular career and creates a curriculum that is a prerequisite to pursue the career.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 illustrates a plurality of customizable electronic education systems communicating with a results server, an educational institution server, and a coaching institution server through a network according to an embodiment herein;

FIG. 2 illustrates a block diagram of a customizable electronic education system having a Processor, a keyboard, a mouse, a power supply, an Ethernet, external storage devices, a USB connector, a flash memory, a Random Access Memory (RAM), a Secure Digital Input Output (SDIO) connector, a debug connector, a video formatting chip, and an audio formatting chip according to an embodiment herein;

FIG. 3A is a block diagram illustrating functional modules of a customizable electronic education system according to an embodiment herein;

FIG. 3B illustrates a flow diagram of a user interface of a software framework of a customizable electronic education system, the user interface having a run module, a manager application, a subjects module, an accounts module, a reset password module, a topics module, a login module, a welcome module, an add user (addUser) module, a delete user (delUser) module, a settings module, an auto mode module, a manual mode module, a test module, a Progress Report (Prog Report) module, a redo module, and a Home Work (HW) module according to an embodiment herein;

FIG. 3C is an exploded view of the session-type selection module of the customizable electronic education system of FIG. 3A according to an embodiment herein;

FIG. 4 illustrates a block diagram of a software framework of a customizable electronic education system having a session module, a screen module, an element button module, a text module, an algebra module, an element matrix module, an image module, a number module, a display layer module, and a display element module according to an embodiment herein;

FIG. 5 illustrates a user interface view of the login module of FIG. 3 according to an embodiment herein;

FIG. 6A illustrates a user interface view of a level setting module of FIG. 3A according to an embodiment herein;

FIG. 6B illustrates a user interface view of a user settings of the settings module of FIG. 3B according to an embodiment herein;

FIG. 6C is user interface view of a grade settings of the setting module of FIG. 3B according to an embodiment herein;

FIG. 7 illustrates a user interface view of the welcome module of FIG. 3 according to an embodiment herein;

FIG. 8 illustrates a user interface view of the topics module of FIG. 3 according to an embodiment herein;

FIG. 9 illustrates a screen displayed during a session of a user, the screen accompanied by a specification file and a keywords file, the screen including a button, a matrix, a control element, and an image according to an embodiment herein;

FIG. 10A illustrates a user interface view of a problem set of questions for addition arranged horizontally according to an embodiment herein;

FIG. 10B illustrates a user interface view of the problem set of questions for addition arranged horizontally of FIG. 10A with answers entered by a user and solutions provided by the software framework according to an embodiment herein;

FIG. 11 illustrates a user interface view of a problem set of questions for addition arranged vertically with answers entered by the user and solutions provided by the software framework according to an embodiment herein;

FIG. 12A illustrates a user interface view of a sheet of an algebra problem based on two random ratios, and a random variable according to an embodiment herein;

FIG. 12B illustrates a user interface view of a systematic step by step solution to the algebra problem of FIG. 12A to arrive at answers according to an embodiment herein;

FIG. 13 illustrates a user interface view of a sheet of an algebra problem based on three random variables according to an embodiment herein;

FIGS. 14A-B illustrates table views of a percentage scores per sheet and corresponding output sounds in response to the answer provided by the user according to an embodiment herein;

FIG. 15 illustrates a user interface view of a results summary of a test taken by the user according to an embodiment herein;

FIG. 16 illustrates a user interface view of a review/rework screen displayed at the end of the test or a session taken by the user according to an embodiment herein;

FIG. 17A illustrates a schema of reaching a next level based on the consistency of the user measured by the consistency module of FIG. 3A according to an embodiment herein;

FIG. 17B illustrates a process of randomizing numerical values in a question by the randomization module of FIG. 3A according to an embodiment herein; and

FIG. 18 illustrates a representative computer architecture used in accordance with the embodiments herein.

### DETAILED DESCRIPTION OF PREFERRED EMBODIMENTS

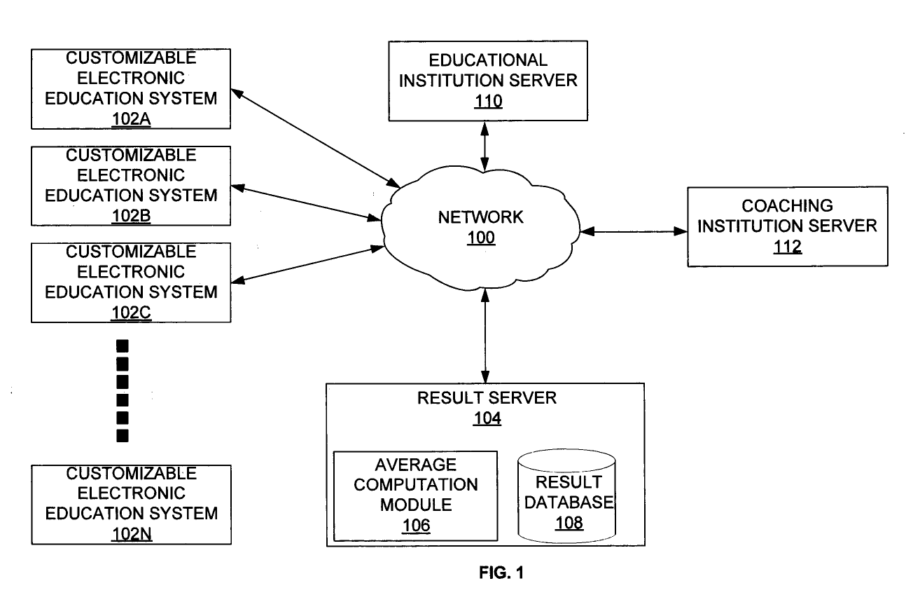

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein. Referring now to the drawings, and more particularly to FIGS. 1 through 17, where similar reference characters denote corresponding features consistently throughout the figures, there are shown preferred embodiments.

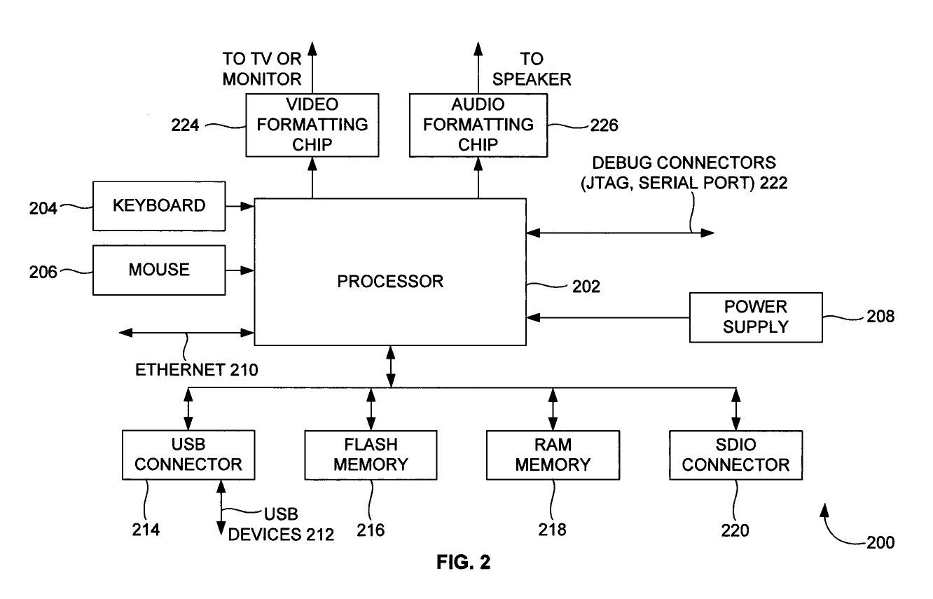

FIG. 1 illustrates a plurality of customizable electronic education systems 102A-N communicating with a result server 104, an educational institution server 110, and a coaching institution server 112 through a network 100 according to an embodiment herein. The result server 104 includes an average computation module 106 and a result database 108. The customizable electronic education systems 102A-N may connect to the network 100 through an Ethernet (e.g., the Ethernet 210 as shown in FIG. 2). The customizable electronic education systems 102A-N may also form a user group and share work sessions amongst them. The customizable electronic education systems 102A-N may transmit results of user sessions to the result server 104.

The results of the user sessions at various customizable electronic education systems 102A-N are stored in the result database 108. The average computation module 106 computes statistical averages of results, such as over period of time for a given user, over a user group, a school, coaching class, or a national average. Based on the results, a national average is computed. Schools can be compared with each other, one user against the rest of the school or one user against the state or the national average. A session may include a practice session, a homework session, a redo and/or rework session, a test etc. At the end of a test or session at one of the customizable electronic education systems 102A-N, the average may be displayed along with the user's score for comparison. The customizable electronic education systems 102A-N may connect to the educational institution server 110 through the network and access additional tests and practice sessions, updated syllabi, etc.

In one embodiment, the tests and practice sessions are created by the educational institution and they are based on a school or college syllabus prescribed by an educational board. The coaching institution server 112 may include supplementary sessions and tests, homework etc. In one embodiment, the content (e.g., tests and practice sessions) are created by the coaching institution specific to a competitive examination. Alternatively, the content may be created as software by specialist content creators and sold to educational institutions, coaching classes or directly to users.

FIG. 2 illustrates a block diagram of the customizable electronic education systems 102A-N of FIG. 1 each having a processor 202, a keyboard 204, a mouse 206, a power supply 208, an Ethernet 210, external storage devices 212, a USB connector 214, a flash memory 216, a Random Access Memory (RAM) 218, a Secure Digital Input Output (SDIO) connector 220, a debug connector 222, a video formatting chip 224, and an audio formatting chip 226 according to an embodiment herein. In one embodiment, the processor 202 is a Reduced Instruction Set Computer Processor (RISC). The processor 202 may be preferably an ARM processor or an X86 processor. The keyboard 204 may be customized to include education specific keys. The keyboard 204 may be a general purpose keyboard and the mouse 206 may be any mouse that can be used with a personal computer.

The power supply 208 may even be AA or AAA batteries, since the customizable electronic education systems 102A-N consume only as much power as a typical digital camera. The Ethernet 210 provides connectivity to the network 100. In one embodiment, the customizable electronic education systems 102A-N does not have internet connectivity. The USB connector 214 is used to connect the USB devices 212. The flash memory 216 may store various additional modules of the software framework, or supplementary information such as tests, sessions etc. In one embodiment either the USB connector 214 or the flash memory 216 is present. No power is required to store information in the flash memory 216; further the information can be erased and programmed quickly. The Secure Digital Input Output (SDIO) connector 220 connects a SDIO card that similar to that used in portable devices such as digital cameras and mobile phones

The debug connector 222 is optional, and may be a Joint Test Action Group (JTAG) or serial connector. The video formatting chip 224, and the audio formatting chip 226 convert the video and audio output respectively of the processor 202 into either a TV output or a computer VGA/LCD. In addition, there are some capacitors and resistors for setting the voltages etc. Thus, the customizable electronic education systems 102A-N are more compact and they consume much less power than a PC since there is no DVD-ROM, big power supply etc. The power consumption may be less than personal computer by 3 orders of magnitude (e.g., only 300 mW consumption as compared to 300 W for a PC).

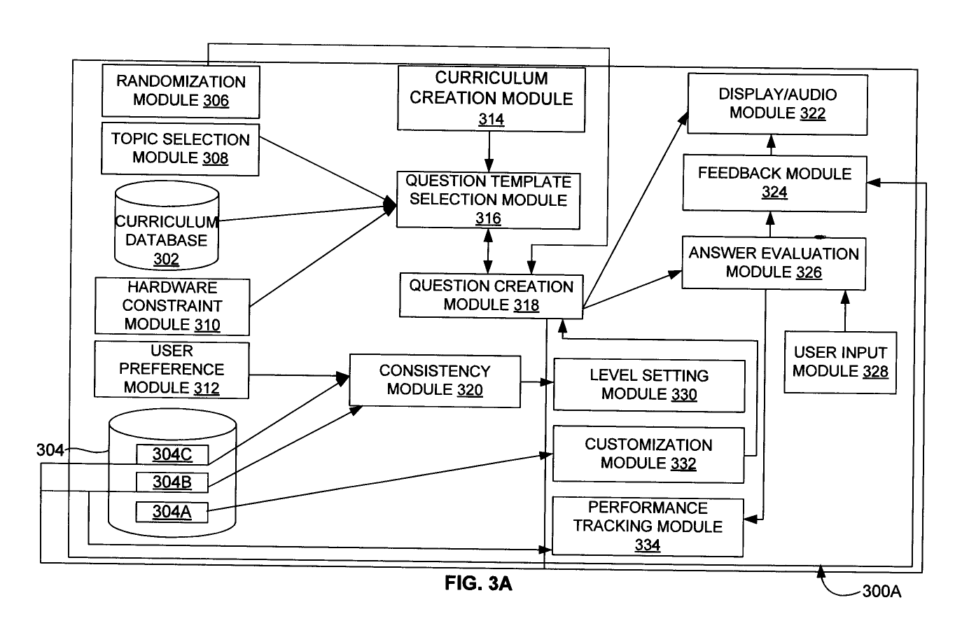

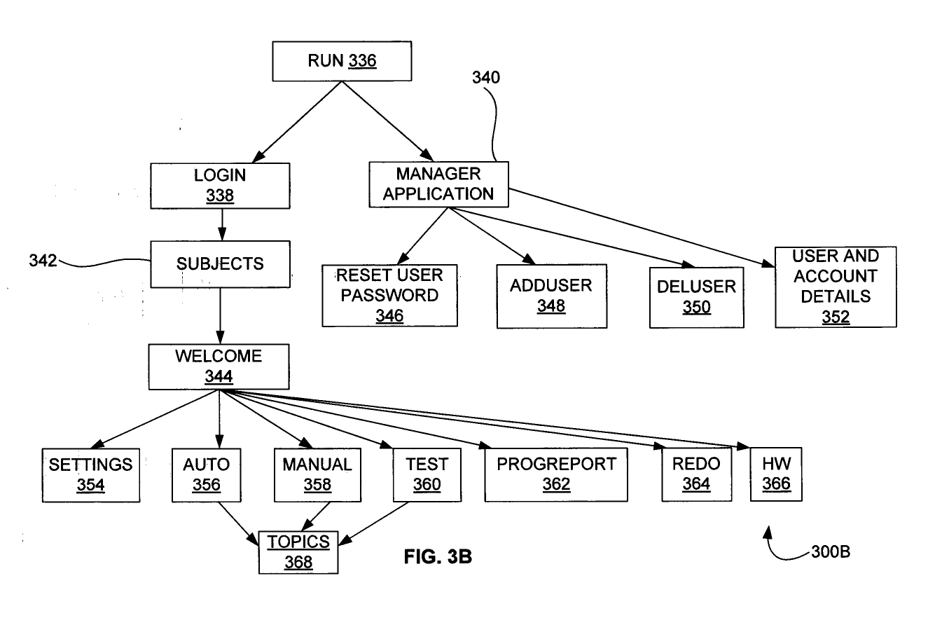

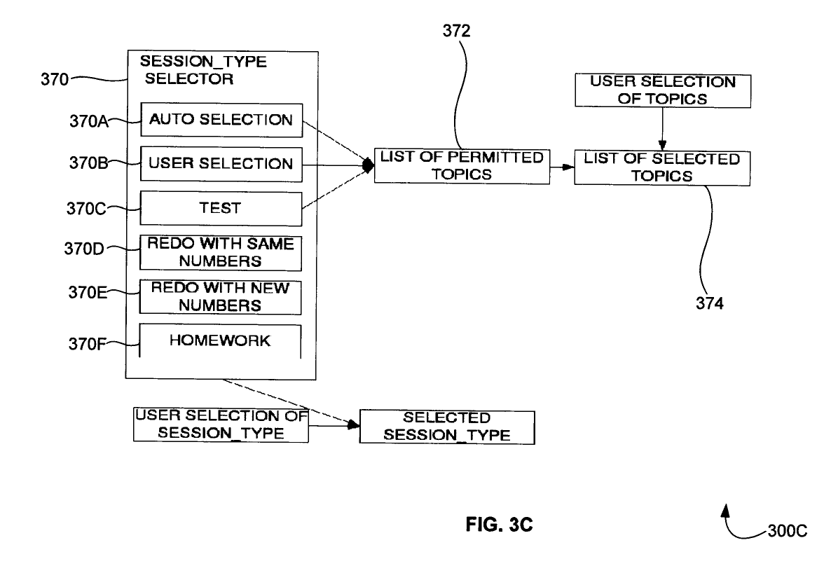

FIG. 3A is a block diagram 300A illustrating functional modules of a customizable electronic education system according to an embodiment herein. The block diagram 300A includes a curriculum data base 302, a user database 304, a randomization module 306, a topic selection module 308, a hardware constraint module 310, a user preference module 312, a curriculum creation module 314, a question template selection module 316 and a question creation module 318, a consistency module 320, a display/audio module 322, a feedback module 324, an answer evaluation module 326, a user input module 328, a level setting module 330, a customization module 332 and a performance tracking module 334.

The curriculum database 302 stores hierarchical curriculum data of a course of study (e.g. subjects, levels, sub-levels, topics etc.). The curriculum database 302 contains questions relating to the curriculum, or syllabus, or exam in a hierarchy, as in there are predefined dependencies between topics and sub-topics with the content being randomizable. The curriculum database also maintains a minimum, maximum, and typical duration required for solving one or more sessions associated with them.

The user database 304 stores a personal information 304A of users including name, gender, class, likes, dislikes, friends, enemies, performance records, history of sessions etc. The user database 304 enables access to a performance information 304B and a past session information 304C.

The randomization module 306 randomizes a feedback from the feedback module 324 within the constraints of a user's performance. In one embodiment, the randomization module 306 gives stars on a good feedback from the feedback module 324 based on the performance as tracked by the performance tracking module 334. A medal is given for a consistent performance. The randomization module 306 randomizes value of variable of a question executed. The topic selection module 308 selects a type of session and further allows the user to select specific topics from the set of topics presented. The session-type may be one of an automatically generated topic-set from which the user may select a set of topics, for which the questions will be automatically generated at the level of the user. The session type may be a user-selected topic-set, from which questions will be generated. In one embodiment, a session type is a test on a chosen set of topics, the test having a timeout, after which duration the computer disables input to the system and enabling the user to go back and forth on the various questions while time is still available to solve the question-set. The session type may also include a rework of earlier performed question sets with either identical or re-randomized numbers or a homework session, which is a predefined set of questions but with randomization specified by the randomization module 306 and customization performed by the customization module 332.

The customization module 332 customizes colours and themes of the user interface of the electronic education system as per the information of a user stored in the user database 304. The customization module 332 enables pre-creation of a set of problems for a test, assignment, homework etc. The randomization module 306 randomizes a feedback from the feedback module 324 within the constraints of a user's performance. In one embodiment, the randomization module 306 gives stars on a good feedback from the feedback module 324 based on the performance as tracked by the performance tracking module 334. A medal is given for a consistent performance. The randomization module 306 randomizes value of variable of a question executed.

The hardware constraint module 310 specifies one or more hardware constraints, and permits the questions to be customized based on hardware constraints such as a virtual keypad for a touch-screen device, discarding decorative images on a screen-constrained hardware device (e.g., mobile), adjusting the font size to maximally utilize the screen space available and laying out the screen based on an aspect ratio of the screen.

The user preference module 312 user preference module which allows the user to choose if questions are to be purely curriculum-based, or allows other types of questions with either deeper understanding or higher numerical calculation requirement. It also enables the user to set a duration for which the questions are to be presented, and the selection of questions being based on the duration specified by the user, and the average duration required to solve various questions. It also enables the user to change the settings in terms of level of comfort in each topic, the number of worksheets to be tracked for consistent performance, the percentage to be achieved to be deemed consistent performance. It also allows the user to set a number of attempts permitted before one or more answers get evaluated by the answer evaluation module 326 and communicates to the display module 322 through the feedback module 324. The user preference module 312 enables to choose a language in which the questions are displayed and the session conducted.

The curriculum creation module 314 extracts a subset of a complete curriculum that is relevant for a particular career, such as a wildlife photographer, space scientist, or architect and creates a curriculum that is sufficient prerequisite to pursue a particular career.

The question template selection module 316 selects question-templates from the curriculum database 302 at a level appropriate for the user, based on feedback from the level-setting module 330. It also enables selection of questions from a list of topic selected by the user in the topic selection module 308 or selection of questions which may or may not have questions of higher difficulty level and deeper understanding based on the inputs from the user preference module 312. In one embodiment, the question template selection module 316 selections questions which are intended to require the user a specific duration to solve, where the duration is specified in the user-preference module 312.

The question creation module 318 integrates the questions selected by the question-template selection module 316 with the randomization provided by the randomization module 306 and the customization provided by the customization module332. Thereafter generating a compositie question with appropriately customized text, numerical values, colors, images and themes. The consistency module 320 measures a consistency with which the user has performed in the topics in which the questions were attempted. The consistency is measure based on the performance (e.g., either percentage or letter-grade or other such measure), the history and number of worksheets attempted in a sub-topic, the duration required by the user to attempt these worksheets. For example, 90% in any 9 of the previous 10 worksheets in average-time or better may be a measure of the consistency of the user. The display/audio module may include any of a display device, an audio playback device, which renders a question generated by the system and the user's answers.

The feedback module 324 feedback module gives positive feedback (e.g. displayed as stars) for good short-term performance (e.g., such as getting 100% in the worksheets of a specific topic in a session). The feedback module 324 gives positive feedback (e.g., displayed as medals) when a consistent performance as determined by the consistency module 320 is achieved in any topic. The feedback module 324 also displays a history of the user's short-term and long-term performance and adapts the feedback given to the user (e.g., sound, text, image) based on the performance of the user in that session. The feedback module 324 further randomizes the feedback given to the user (e.g., sound, text, image) based with the constraints of the user's performance in the session.

The answer evaluation module 326 evaluates the user's answers based on the constrained randomization in the questions, changes the color of a result based on an accuracy of the user's answer, renders a correct answer adjacent to the user's answer in case the user's answer is incorrect and plays an audio sound depending on the accuracy of the answer. The user input module 328 enables the user to process input to the system.

The level setting module 330 sets the levels of tests, assignments, homework and questions in various topics and subjects as per the performance of the user in the tests, assignments, homework and questions of various topics and subjects. It sets the levels for various topics which will be appropriate for the user based on the user's past performance and personal information. The customization module 332 customizes the questions selected by the question-template selection module 316 with the names of the student, his friends, his enemies, the personal likes, dislikes of the student, colors, images, and themes appropriate to the age and gender of the student and modifies text to be grammatically correct for the gender of each of the student, his friends, and enemies. For example, the user likes a particular sports team, a particular actor, festival, colour etc., then the questions framed will have scenario including the user's favourite sports team, colour etc.

The performance tracking module 334 tracks one or more worksheets attempted, score, and duration required. Based on the correctness of the user's answer, as determined by the answer-evaluation module 326, the performance tracking module 334 updates the performance information 304 B and past session information 304 C in the student database 304.

FIG. 3B illustrates a flow diagram 300B of a user interface of a software framework of a customizable electronic education system (e.g., one of the customizable electronic education systems 102A-N of FIG. 1), the user interface having a run module 336, a login module 338, a manager application 340, a subjects module 342, a welcome module 344, a reset user-password module 346, an add user (addUser) module 348, a delete user (delUser) module 350, a user-and-account details module 352, a settings module 354, an auto mode module 356, a manual mode module 358, a test module 360, a Progress Report (Prog Report) module 362, a redo module 364, and a Home Work (HW) module 366 and a topic module 368 according to an embodiment herein. The software framework may be executed at the processor 202.

The run module 336 controls the overall flow both for the user and the teacher. For the user, the run module 336 controls the flow from login to grading windows, sets a list of problems depending on the mode selected by a user (e.g., automatic or manual), and performs grading functions after a user input. The run module 336 may also include a parsing module that parses directories and sets topics. The login module 338 sets up a display screen to allow a user to log on. The subjects module 342 allows the user to select a subject he wishes to work on from a list of subjects given, for example Math, Science, History, etc. The welcome module 344 handles user choices and give control to one of the modules such as the settings module 354, the auto mode module 356, the manual mode module 358, the test module 360, the Progress Report (Prog Report) module 362, the redo module 364, the Home Work (HW) module 350 and the topics module 352. The settings module 354 sets up user levels, user details, and grading settings. It also handles changes in settings and gives control back to the welcome module 344. The auto mode module 356 sets an automatic mode based on a user selection. It gives the choice to the user to select particular sublevels for session depending on the child's level and topic dependencies. The manual mode module 358 allows the user to manually select topics, sessions, tests, etc based on the user preferences. The test mode allows the user to manually select duration, topics, levels and sublevels for the test. The topics module 352 sets a complete structure including topic settings, levels and timings.

The manager application 340 includes a reset-user-password module 346, an add-user module 348, a delete-user module 350, and a user-and-account-details module 352. The reset-user-password module 346 resets the user's password and returns control to the manager-application 340. The add user (addUser) module 348 handles add user events and gives control back to the manager-application 340. The delete user (delUser) module 350 handles delete user events and gives control back to the manager-application 340. The user-and-account-details module 352 presents financial details (hours used, payment owed) of the users. This module returns control to the manager-application module 340.

The test module 360 enables a test mode in which questions are displayed to the user, answers requested and the results are computed. The Progress Report (Prog Report) module 362 parses the user's performance and displays a report that may include a percentage, an amount of time taken etc. The redo module 364 enables the user to rework the session based on the same or different random numbers. In one embodiment, the Home Work (HW) module 366 gets connected to the educational institution server 110 or the coaching institution server 112 to download additional sessions, tests or supplementary material. It also parses downloaded directories and sets up groups, subgroups, sessions, tests etc, handles user choices, and enables a HW mode.

FIG. 3C is an exploded view 300C of the session-type selection module 308 of the customizable electronic education system of FIG. 3A according to an embodiment herein. The exploded view 300C includes a session type selector 370, a list of permitted topics 372 and a list of selection topics 374. The session type selector 370 includes an auto selection module 370A which enables the user to make an auto selection of a session type with auto selection of topics. The user selection module 370B enables the user to set session as well as select topics from the list of permitted topics 372. The test module 370C generates a test from the list of permitted topics 372. The redo with same numbers module 370D enables the user to rework the test with same numerical values. The redo with same numbers module 370E enables the user to rework the test with new numerical values.

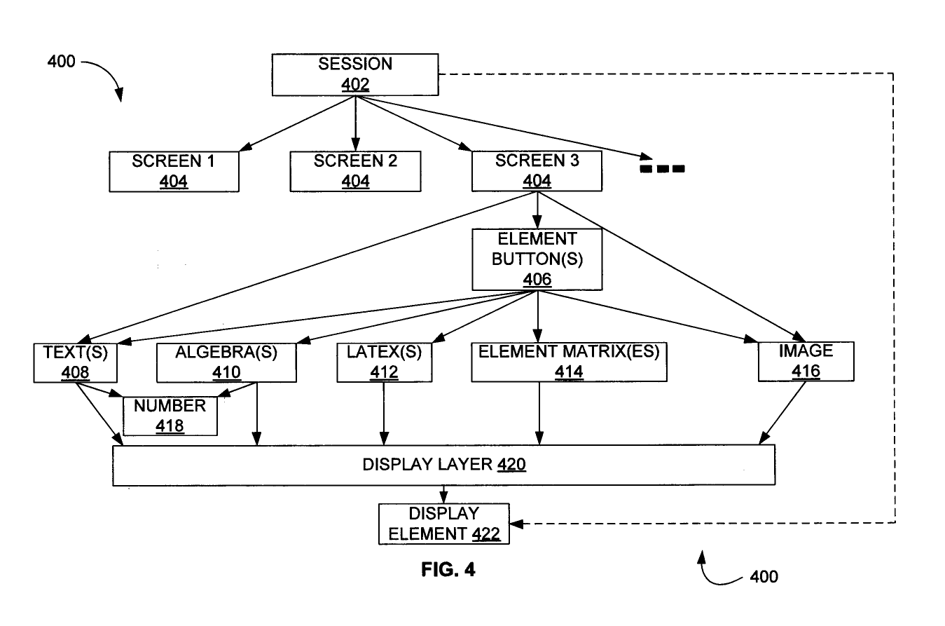

FIG. 4 illustrates a block diagram of a software framework 400 of a customizable electronic education system (e.g., the customizable electronic education systems 102A-N of FIG. 1) having a session module 402, a plurality of screen modules 404, an element button module 406, a text module 408, an algebra module 410, an element matrix module 412, an image module 414, a number module 416, a display layer module 418, and a display element module 420 according to an embodiment herein. The session module 402 sets up the screen module 404 based on an input control file. The session module 402 also sets up information in the display layer module 418 and executes the display to gather user inputs. It passes control to a screen module 404 to grade an input from a user and creates one or more new screens.

The screen modules 404 include element array information, control information, random information, a user input information, a user correction information, and a state information. The screen modules 404 read the input file or array and control information, fill the element array, and arrange a screen accordingly. The screen modules 404 also receive the user input information, perform a grading of user answers, update the screen, and update the state. The element button module 406 may include a picture name, font information, a location, a list of elements, a list of positions, position modifiers, color information for a random number, color information for a user input, color information for an answer, color information for wrong information, and color information for a right answer. The element button module 406 fits an arrangement in the smallest area possible. An image is used as the background for an element button.

The text module 408 parses the input file to obtain text information and sets the information into a low level text. It converts random numbers to text that is printable on the screen. The text module 408 sets an element's position in a sequence of arrow keys, determines a previous and next element in the sequence of arrow keys, and writes out information to a higher level caller that will use it to render. The algebra module 410 includes a low level text, font information, a location, list of coefficients, a list of variables, and a list of exponents. In one embodiment, the algebra module 410 supports an expression such as 3x̂(4/5)−2x+1, where “3” is the coefficient, “x” is the variable, and “⅘” is the exponent. The algebra module 410 parses the input and sets internal elements, returns information to a higher level caller, allows the user to make modifications by adding characters or changing positions, and prints the string to a higher level caller.

The element matrix module 412 includes elements (e.g., text, images, algebraic expressions) arranged in rows and columns. The column widths are set to be wide enough to contain the widest element in that column. Similarly the row heights are set to be enough to contain the tallest element in that row. The input is parsed to obtain the elements. Position modifiers, font information, and location information are read to find the width and height of each element, and the position of each element is computed. Position modifiers (e.g., a separation between columns) are applied.

Information is returned to a higher level caller. The element matrix module 412 sets the positions of various elements in the sequence of arrow keys and determines the previous and next element in the sequence of arrow keys for each element. The image module 414 reads a filename and control information (e.g., position, scaling requirements) and sets up the size and location information. The number module 416 includes a sign information of a number, a number of integer digits, a number of fractional (e.g., decimal) digits, and an actual value of the number.

The number module 416 performs one or more functions that may include generating a random number between two given numbers, generating a sum/difference/product/quotient/remainder of two previously defined numbers, shifting a number up or down by a given number of decimal places, generating a number relatively prime to a given number, extracting a particular digit of a number, canceling out common factors between two numbers and returning the values, raising a number to a given power, rounding a number to a given number of digits, finding the factorial/absolute value of a number, comparing two numbers, returning whether the comparison was true or false, extracting a number from a number array, and extracting the min/max/mean/median/mode/range of a number array.

The display layer module 418 parses a string and fills up list of elements and other control information. It may also invoke a current element. If a user input requests a switch element, it updates a current element number. It may call each element and send a request to redraw its portion of screen. The display element module 420 parses a string and determines a type of element and other control information. It also handles user events, such as keyboard strokes, and redraws the portion of screen on which the element is located.

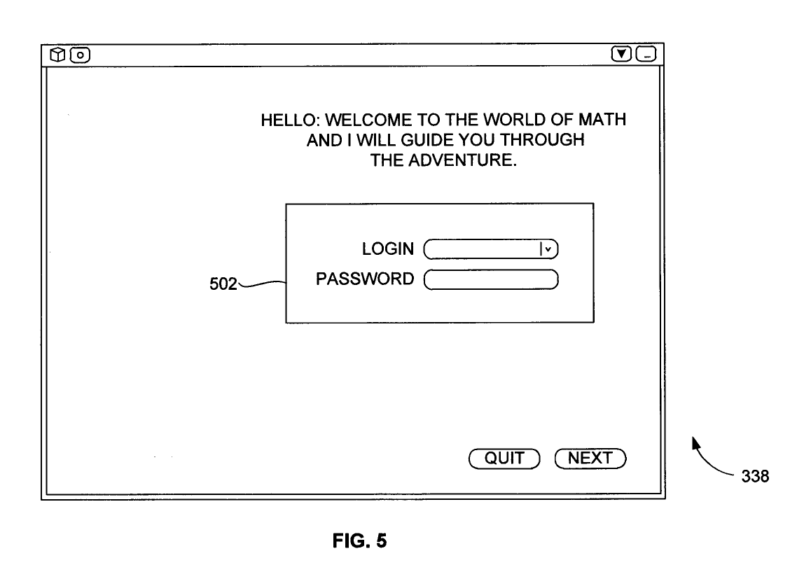

FIG. 5 illustrates a user interface view of the login module 322 of FIG. 3 according to an embodiment herein. The user interface view includes a login and password box 502. A user may type a login id and password in the login and password box 502 to gain access to an account of the user. The user may be an administrator.

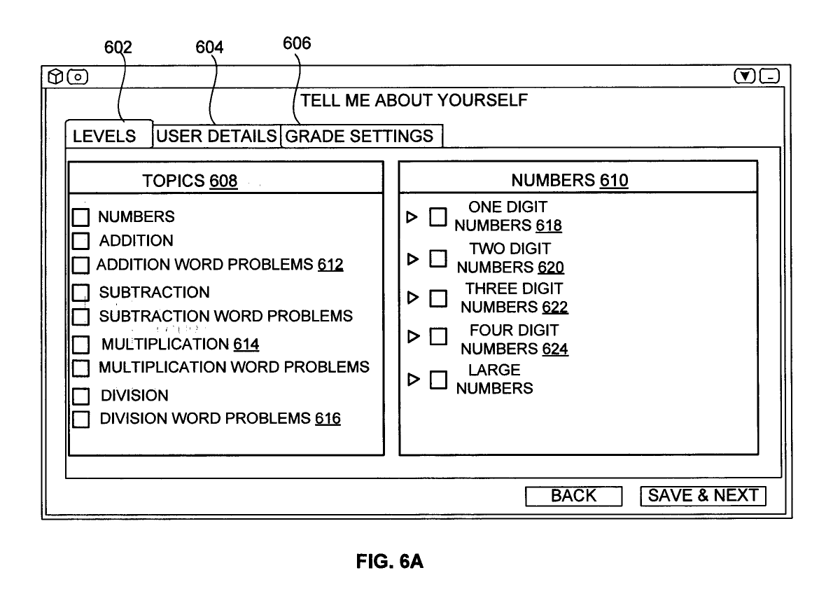

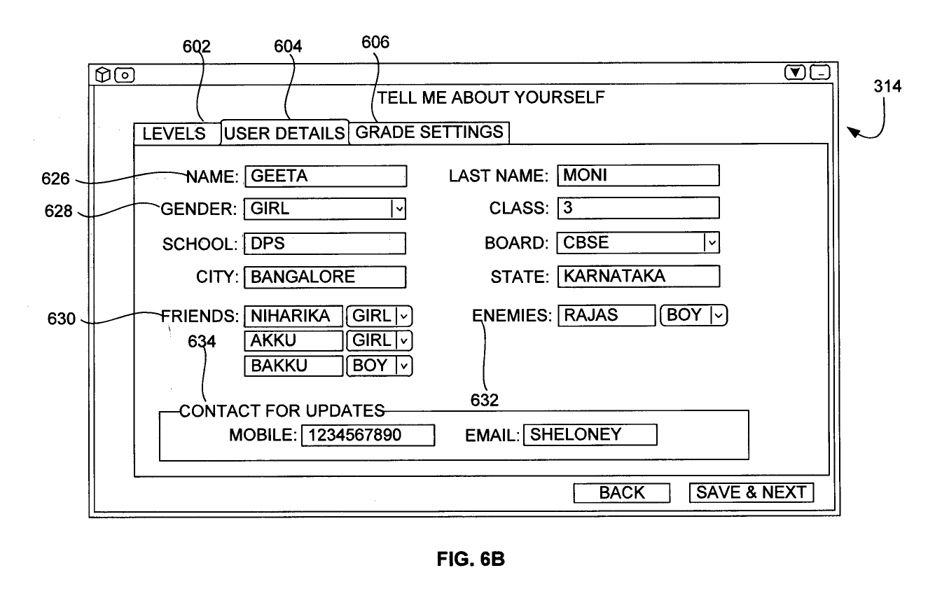

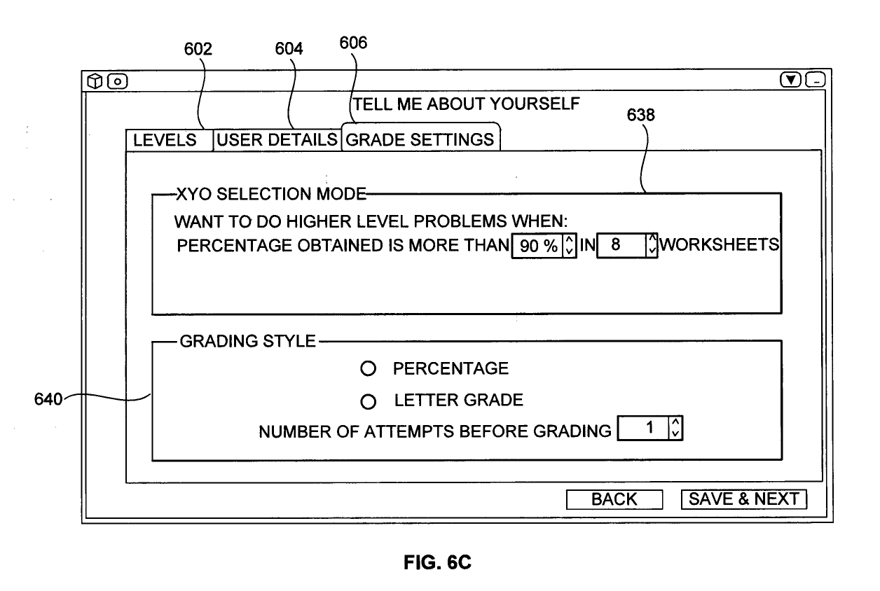

FIG. 6A illustrates a user interface view of a level setting module of the setting module 338 of FIG. 3B, according to an embodiment herein. The user interface includes levels 602, user details 604, grade settings 606, a topics 608 and a numbers 610. At this interface, a guardian or teacher of a user can set level of questions to be posed to the user in a test. By checking required boxes falling under the topics 608, the test may be designed specific to the topics selected. For example, the guardian/teacher checks addition word problems 612, multiplication 614 and division word problems 616, the test will constitute questions only from these topics. By checking require boxes corresponding falling under the numbers 610, a difficulty level of the test is set. For example, a guardian/teacher checks one digit numbers 618 and two digit numbers 620 in order to make the test easier. The guardian/teacher may check three digit numbers 622 and four digit numbers 624 to make the test relatively difficult.

FIG. 6B illustrates a user interface view of the user details 604 of settings module 354 of FIG. 3 according to an embodiment herein. The user interface includes levels 602, user details 604, grade settings 606, a user name 626, a gender 628, a friends list 630, an enemies list 632, and a contact for updates field 634. The user details 604 may include information related to the user such as the user name 626, gender 628, class, board, school, city, state etc. In one embodiment, the user details may include a language preference, and problems may be displayed in the chosen language.

Certain user details may be only modified by an advanced user (e.g., a parent, a teacher, or an administrator) and is protected by a teacher password. Further, financial details are protected by a separate manager-password. The user details 604 may be used by various modules of the software framework 400 of FIG. 4 such as the screen module 404, the text module 408, the image module 416 etc to personalize the session and customize various steps such as level, preferences, display, images, text, grading, transmission and updating of results etc. The problems that are displayed during the user session are also customized by including the user name 626, the friends list 630, the enemies list 632 etc. The contact for updates field 634 may include an email address and/or a mobile number of a tutor, a parent or guardian.

FIG. 6C is user interface view of the grade settings 606 of the setting module 338 of FIG. 3B according to an embodiment herein. The user interface includes levels 602, user details 604, grade settings 606, a selection mode 636 and a grading style 638. The user interface enables setting up of grading style and also enables the guardian/teacher to set the consistency levels. The selection mode 636 enables guardian/teacher to define consistency levels as well as to customize the test difficulty level as per the consistency. In one embodiment, if the user obtained more than 90% marks in 8 worksheets, the user is allowed to take tests with higher difficulty level problems.

The grading style of the tests may also be customized by the grading style 638. The guardian/teacher can choose from a number of grading styles available. In one embodiment, the grading style is either via percentage or letters grade. The grading can be customized to begin after a certain number of attempts. In one embodiment, the test is graded only after one attempt. The test may be customized to be graded after one or more attempts.

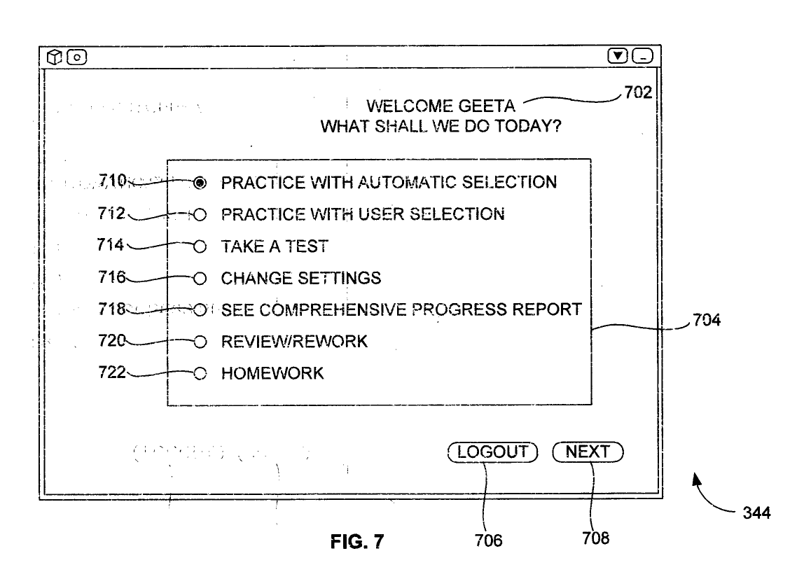

FIG. 7 illustrates a user interface view of the welcome module 344 of FIG. 3B according to an embodiment herein. The user interface view includes a welcome text 702, a checkbox 704, a logout button 706, and a next button 708. The check box 704 includes a practice with automatic selection option 710, a practice with user selection option 712, a take a test option 714, a change settings option 716, a see comprehensive progress report option 718, a review/rework option 720, and a homework option 722 according to an embodiment herein. The practice with automatic selection option 710 if selected displays tests and lessons starting from a basic level.

Depending on the user's comfort with the subject matter of the lessons and performance on the tests, the lessons and test problems are customized. In one embodiment in which a user selects an automatic mode, the user completes addition and subtraction problems successfully and a set of multiplication related problems are displayed on a level of increasing difficulty. If the user fares poorly in addition, the multiplication problems may not be displayed until the user completes the addition problems with a certain level of accuracy. The practice with user selection option 712 allows a user to manually select a topic and a difficulty level for practice.

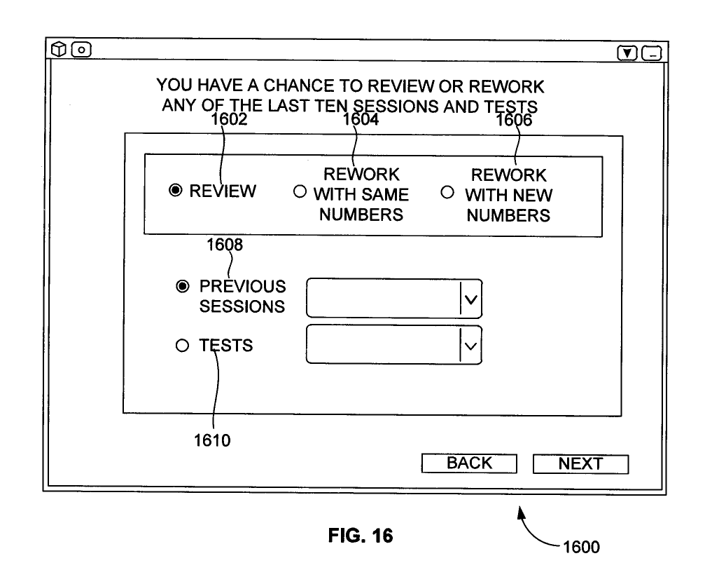

The take a test option 714 administers a test to the user. The change settings option 716 navigates to the user settings screen of FIG. 7. The see comprehensive progress report option 718 displays a detailed progress report for the user over a period of time including practice sessions completed, tests taken, test results, average scores, statistical analysis of comparative performance etc (e.g., by connecting to the result server 104 using the ethernet 210). The review/rework option 720 displays the review/rework screen of FIG. 16 that allows the user to either review the previous sessions and test or take any test or practice session with new numbers. The homework option 722 allows the user access to an additional session that may reside either on a remote server (e.g., the educational institution server 110 or the coaching institution server).

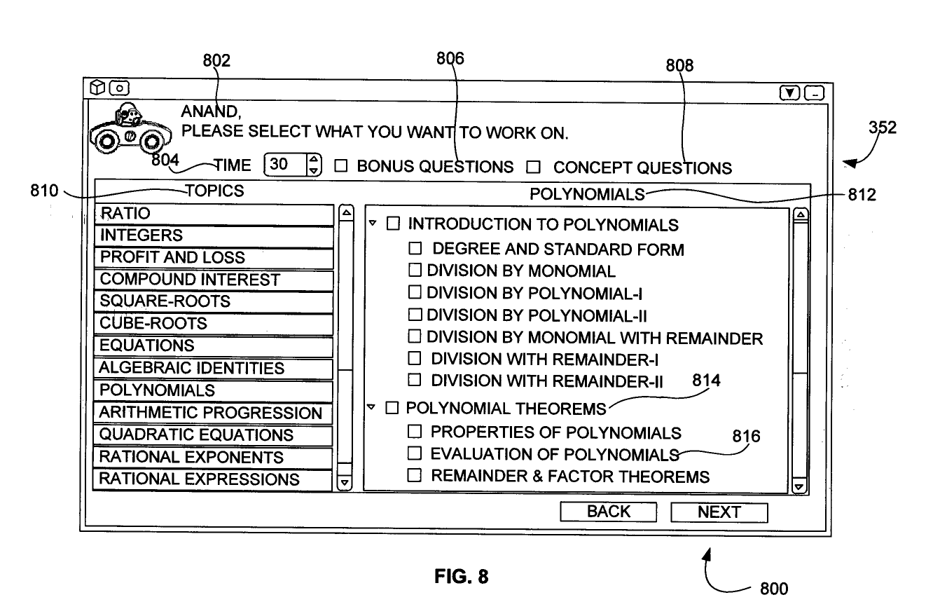

FIG. 8 illustrates a user interface view of the topics module 352 of FIG. 3 according to an embodiment herein. The user interface may include a user name 802, a time selection 804, a bonus questions selection 806, a concept questions selection 808, a topics list 810, a selected topic 812, a category 814, a sub-category 816 etc. The time selection 804 allows the user (e.g., Anand) to select a time for a session. The bonus questions selection 806 allows the user to select an additional tricky question, and the concept questions selection 808 allows the user to select an application based question (e.g., based on a particular situation that the user can relate to). The topics list 810 displays a list of topics relating to a particular subject (e.g., math) ranging from simple to complex such as ratio, profit and loss, polynomials, quadratic equations etc. A selected topic 812 (e.g., polynomials) may include multiple categories 814 (e.g., polynomial theorems), and sub-categories 816 (e.g., evaluation of polynomials) as shown in FIG. 8.

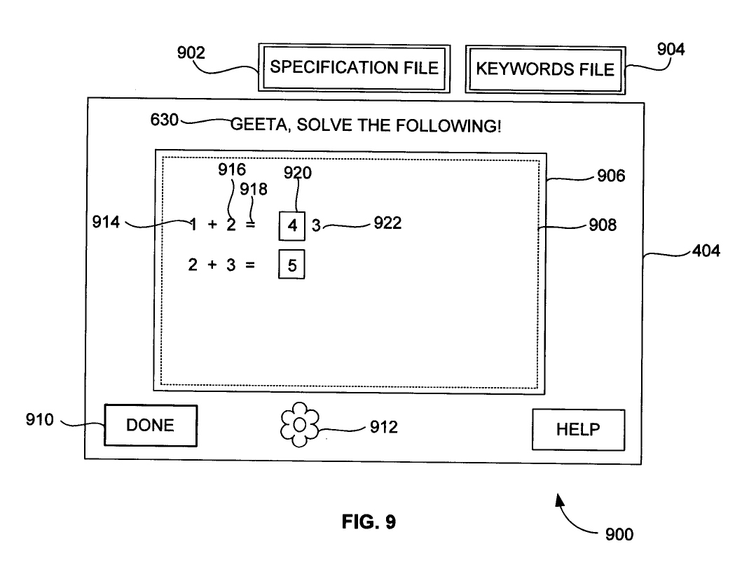

FIG. 9 illustrates a screen 404 of FIG. 4 displayed during a session of a user, the screen 404 accompanied by a specification file 902 and a keywords file 904, the screen 404 including a button 906, a matrix 908, a control element 910, and an image 912 according to an embodiment herein. The matrix 908 is within the button 910 and includes a first random number 914, a second random number 916, a text value 918, a user's answer 920, and a correct answer 922. The screen 404 is one of multiple screens during a session. For each screen 404, there is a corresponding specification file 902 and for each user 608, there is a corresponding keywords file 904. The specification file 902 specifies the layout on the screen, as well as the numerical and other values the screen 404 such as random numbers, an array of numbers, dependent numbers etc. In the specification file 902, a control on a number of integer digits, a number of decimal digits, whether a number is signed or unsigned, a minimum value, and a maximum value may be specified by a content creator (e.g., a teacher, a parent, or a tutor). The colors and themes are adapted based on the age and gender of the child. Furthermore, the selection of images is randomized within this age and gender constraint so that the child doesn't feel ennui. Also, the keywords file has keywords (such as beachThing, farmAnimal, etc) where the user can enter their favourite beach object or farm animal, and this beach object or farm animal appears in the problem.

The first random number 914 is an unsigned, 1 integer digit, 0 decimal digits, having a minimum value of 1, and a maximum value of 8. The content creator may also specify an array of previously declared numbers. This array can be indexed, and numbers extracted from it. Dependent numbers are an arithmetic operation on previously declared random numbers. Some arithmetic operations that supported include add, subtract, multiply, quotient, remainder, shift-decimal-point, extract-nth-digit, generate-a-relatively-Prime-number, cancel-common-factors, power, round, factorial, absolute-value, comparison-operations. A dependent number may also be an element of a previously declared array of numbers. The correct answer 922 is dependent number that is a sum of the first random number 914 and second random number 916.

The user's answer 920 is a variable that holds an answer provided by the user 608. The specification file 902 may also contain a line of text or a string such as “$Childname, solve the following!” in which the keyword, $Childname, is substituted with the child's name (e.g., Geeta) by extracting that information from the keywords file 904. Another text value 918 is an “equal to” sign between the second random number 916 and the user's answer 920. The keywords file 904 contains user-specific information such as the string $Childname which contains the user's name. Objects such as “FavouriteFood” may also be specified, which may be set to “Cake” in one embodiment. These keywords also appear in the text values of the specification file 902.

The button 906 may be added to enhance visual appearance. On top of the button 906, matrices 908 and any of the elements that may appear inside matrices 908 themselves, including numerical elements (e.g., the first random number 914 and second random number 916), text values (e.g., Geeta), algebras, user answers 920, corrected answers 922, and images 912 may be included. An “algebra” is a text representation of an algebraic expression. Conventions of an algebraic expression are respected in generating the text. In one embodiment, a variable “x” with a numerical coefficient “1”, is simply displayed as “x”. However, if the value of the numerical coefficient is something other than “1”, such as 2, then the resulting expression would be “2x”.

The matrix 908 includes various elements arranged rows and columns. In one embodiment, the matrix 908 is a matrix of 2 rows and 6 columns. The first column contains a first random number 914, the second column contains a text (the “+” sign), the third column contains a second random number 916, the fourth column contains text value 918 (the “=” sign), the fifth column contains the user's answer 920, and the sixth column contains the corrected answer 920. The control element 910 controls the flow of the session. For example the “Done” element as shown, allows the user to specify that he is done with the current sheet and wishes to move on. One of the user answer fields or control elements is highlighted, and this indicates what the user's keystroke will control.

An example of the highlight is shown. The color and width of highlight can be controlled in the specification file 902. The screen may include one or more images 912 either to liven up the screen, or images that are an integral part of the question. An example of an image 912 is a flower a shown. Images 912 are chosen based on the gender of the child, which is specified in the keywords file 904. In one embodiment, the user name 608 is ‘Geeta’, the gender 610 is ‘girl’, and the image 912 is a flower. Further, additional images, colors and themes may be displayed on screens based on the user details 604 including age.

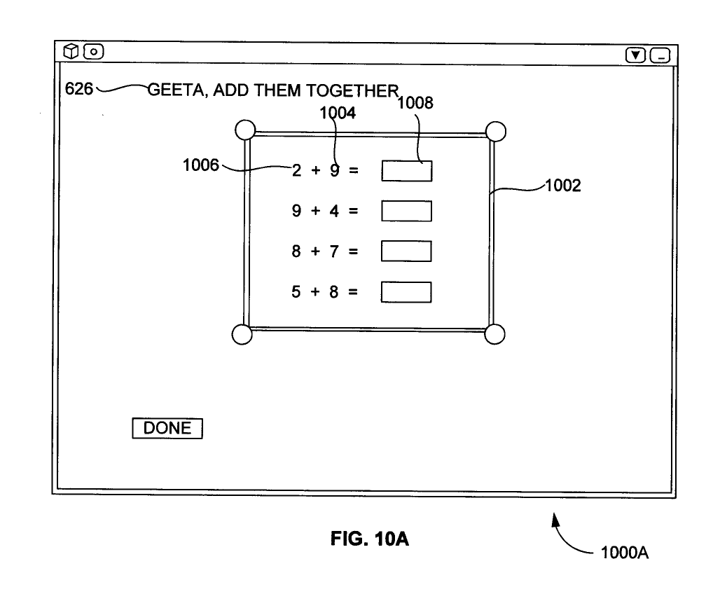

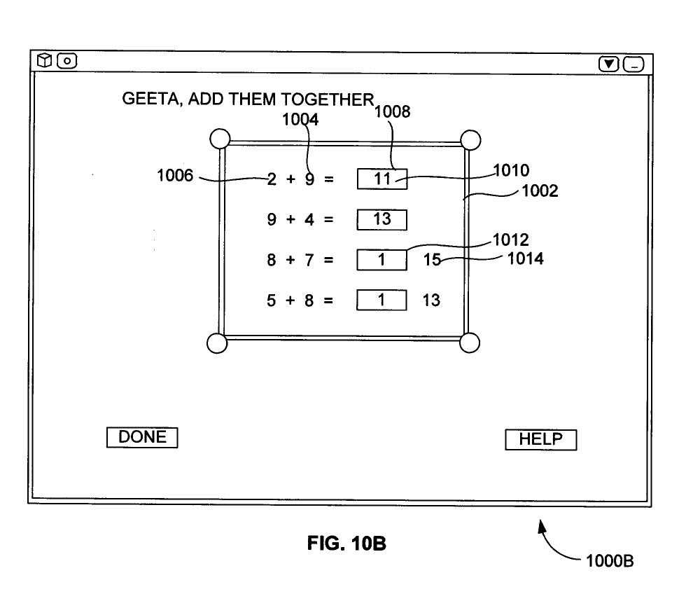

FIG. 10A illustrates a user interface view of a problem set of questions for addition arranged horizontally according to an embodiment herein. The user name 626 is displayed based on the information stored in the keywords file 904. The first random number 1004 and the second random number 1006 are displayed in boxes within the button 1002. FIG. 10B illustrates a user interface view of the problem set of questions for addition arranged horizontally of FIG. 10A with answers entered by a user 608 and solutions provided by the software framework 400 according to an embodiment herein. The box 1008 contains the user's answer 1010 and is highlighted as shown. In the first row, the user's answer 1010 is correct and no additional box is shown to the right. However, in the third row, the box 1012 contains a wrong answer from the user and the correct answer 1014 is displayed in a column to its right as shown in FIG. 10B.

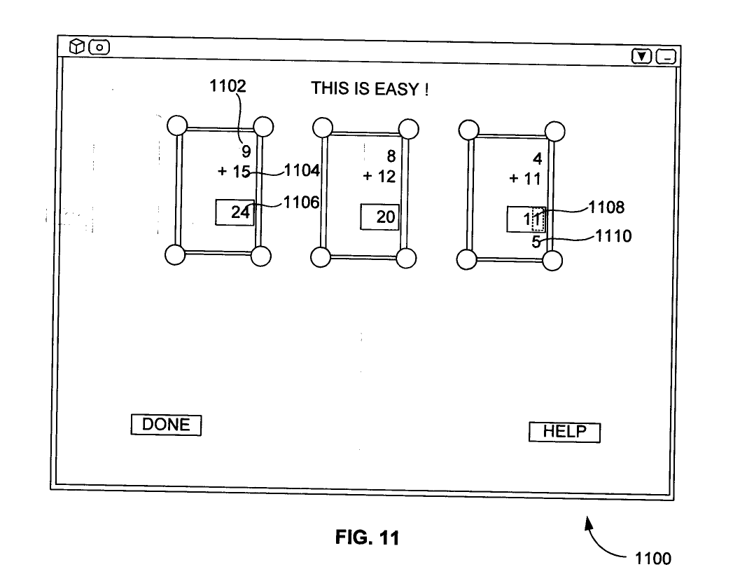

FIG. 11 illustrates a user interface view of a problem set of questions for addition arranged vertically with answers entered by the user according to an embodiment herein. The button 1100 includes a first random number 1102 and a second random number 1104 vertically below it. The user's answer 1106 is below the second random number 1104. In the third button from the left, the user's answer has one digit 1108 highlighted because that digit does not match with the corresponding digit of the correct answer. Only the correct digit 1110 is displayed below the incorrect digit 1108.

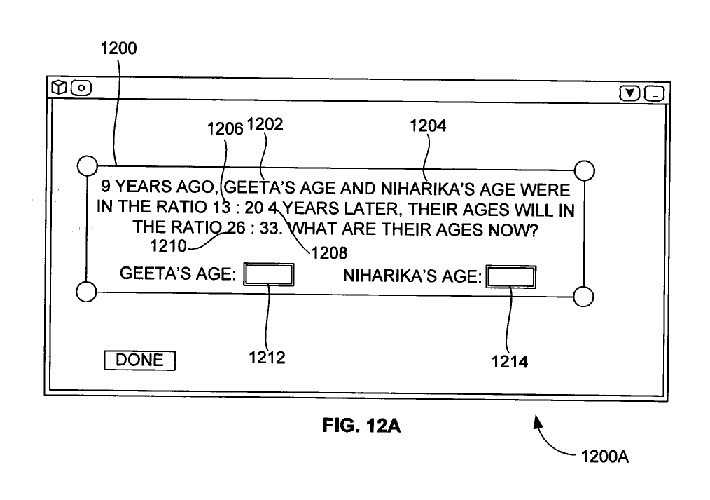

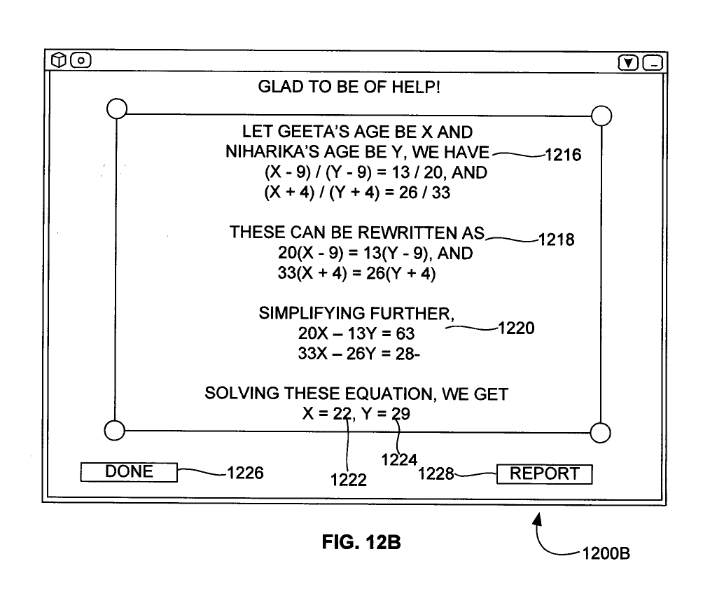

FIG. 12A illustrates a user interface view of a sheet of an algebra problem based on two random ratios 1206 and 1210, and two random variables 1200 and 1208 according to an embodiment herein. The user name 1202 and the name of a friend 1204 from the list 612 are displayed based on the keywords file 904. The first answer 1212 and the second answer 1214 have to be entered by the user. FIG. 12B illustrates a user interface view of a systematic step by step solution to the algebra problem of FIG. 12A to arrive at answers according to an embodiment herein. The first step 1216 includes the user name 1202 and the name of a friend 1204, the random ratios 1206 and 1210, the random variables 1200 and 1208. The second step 1218 illustrates the values of the first step rewritten and the third step 1220 illustrates a further simplification of the equation of the second step 1218. The final answers 1222 and 1224 are then displayed. The user may then either click on the control element ‘done’ 1226 to end the session or the report element 1228 to report feedback on the worksheets.

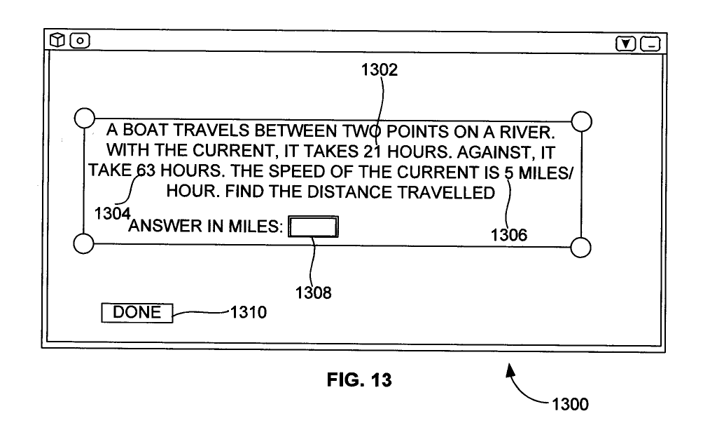

FIG. 13 illustrates a user interface view of a sheet of an algebra problem based on three random variables 1302, 1304 and 1306 according to an embodiment herein. The user may enter the answer in the answer box 1308 and select the ‘done’ element 1310.

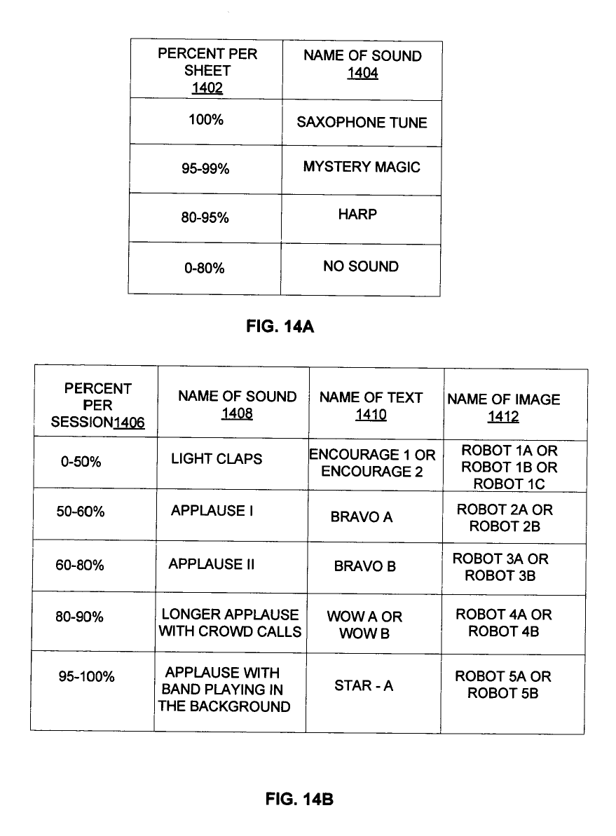

FIGS. 14A-B illustrate table views of a percentage scores per sheet and corresponding output sounds in response to the answer provided by the user according to an embodiment herein. The sounds are played at the end of each sheet as well as the end of a session. In one embodiment, if the percent per sheet 1402 is within the range of 0-80, no sound is produced. For a percent per sheet 1402 value of 100, a saxophone tune is played as output.

In another embodiment, for a percent per session 1406 value in the range of 0-50, light claps/faint applause is played accompanied by a text encourage 1 or encourage 2 along with an image robot 1a or robot 1b or robot 1c. For higher ranges of percentages, the sound is louder with more accompaniments. For percent per session 1406 value in the range of 90-100, applause with a band playing in the background is produced as output accompanied by a Star-A text along with an image of robot 5a or robot 5b. In another embodiment, the audio output is accompanied with video output or images in various colors and themes. The outputs may be used for feedback either at the end of a problem or at the end of a session.

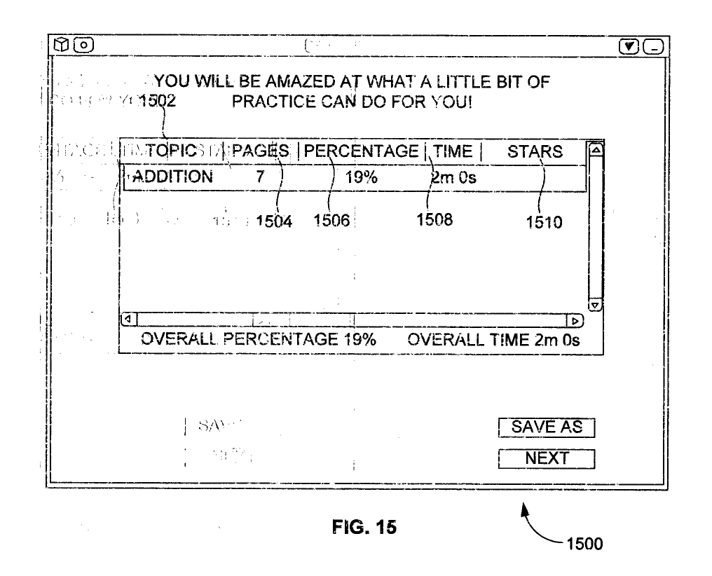

FIG. 15 illustrates a user interface view 1500 of a results summary of a test taken by the user according to an embodiment herein. The user interface view 1500 includes a topic 1502, a pages 1504, a percentage 1506, a time 1508 and stars 1510. The user interface view 1500 displays a topic 1502 attempted along with related pages 1504 and a percentage 1506 obtained in the topic 1502. It also displays the time 1508 taken by the user to attempt a session or topic along with the stars 1510 obtained as the feedback. The user interface view also displays overall percentage and overall time.

FIG. 16 illustrates a user interface view of a review/rework screen displayed at the end of the test or session taken by the user according to an embodiment herein. The user interface includes a review option 1602, rework with same numbers option 1604, a rework with new numbers option 1606, a previous session option 1608, and a tests option 1610. The rework with new numbers option 1606 displays the problems of the session with entirely different random numbers. There is provision for the teacher to use the teacher-password to log in to a user's account, and either review the user's comprehensive report, or review the user's work or change the user's settings. The teacher will not be allowed to work on the content in the user's account.

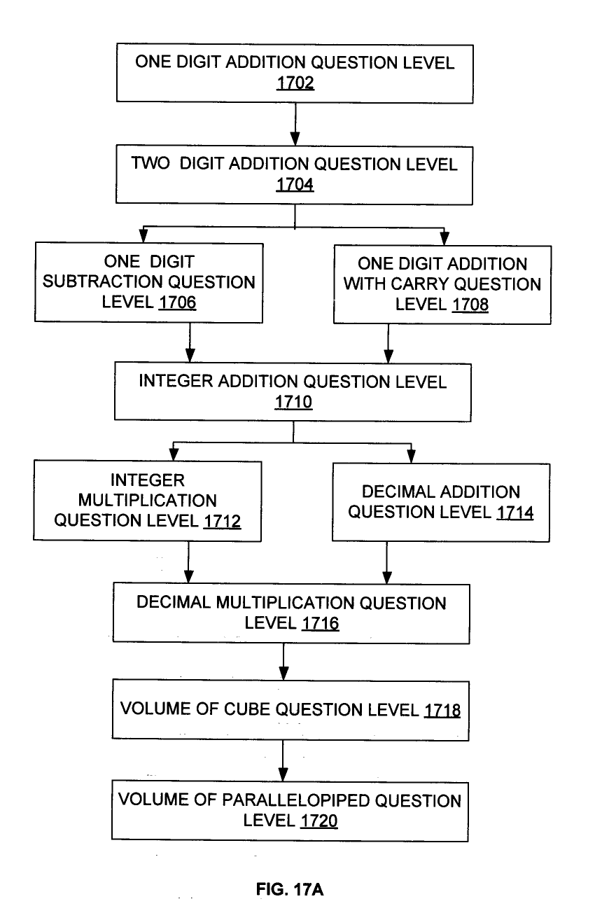

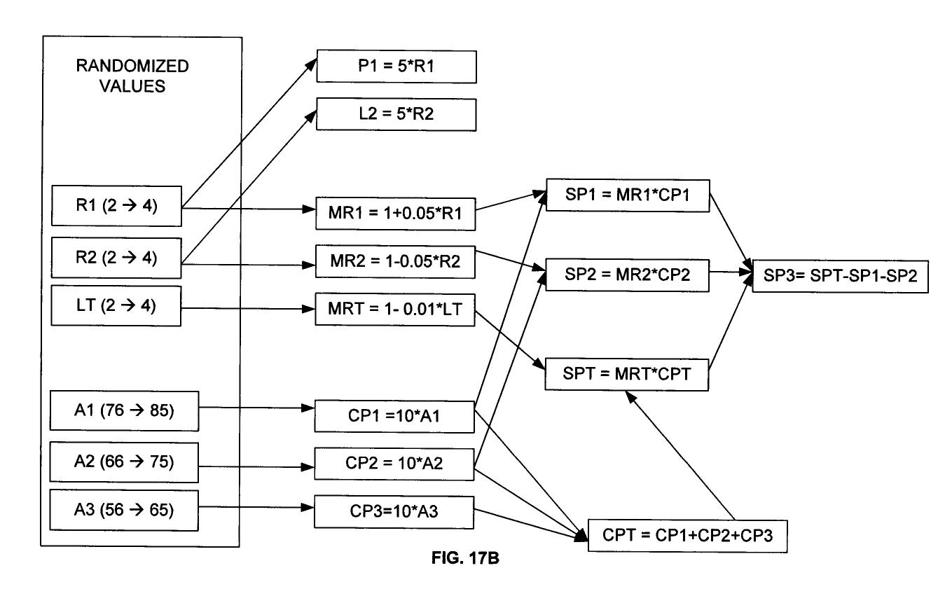

FIG. 17A illustrates a schema 1700 of reaching a next level based on the consistency of the user measured by the consistency module 318 of FIG. 3A according to an embodiment herein. As shown in the FIG. 17A the user is allowed to attempt a two digit addition question level 1704 when the user obtains a consistency in solving a one digit addition question level 1702. If the user gains consistency in the two digit addition question level 1704, then the user is allowed to choose from either of a one digit subtraction question level 1706 or a one digit addition with carry question level 1708. The integer addition question level 1710 is allowed to be attempted if the user obtains the consistency in either of the one digit subtraction question level 1706 or the one digit addition with carry question level 1708. On obtaining consistency in the integer addition question level, the user is allowed to attempt an integer multiplication level 1712 and a decimal addition question level 1714. Once the consistency in the integer multiplication level 1712 and the decimal addition question level 1714 is obtained the user is allowed to attempt a decimal multiplication question level 1716. The consistency in the decimal multiplication question level 1716 allows the user to attempt a volume cube question level 1717. A volume of parallelopiped question level 1720 may be attempted on obtaining the consistency in the volume cube question level 1718.

FIG. 17B illustrates a process of randomizing numerical values in a question by the randomization module 306 of FIG. 3A according to an embodiment herein. The process of the randomization depicted in the figure is relevant to a question related to calculation of a cost price of one of the three articles whose selling prices are given along with a profit percentage on selling price of first article, a loss percentage on second article and an overall loss percentage on all articles. The numerical values of all the variables i.e. cost price, selling price, loss percentage, profit percentage etc; are randomized every time the question is posed. The randomization is carried out under constraints of ensuring that all cost prices, all selling prices, all loss or profit percentages relevant to the question comes out as whole numbers. In one embodiment, the randomization is carried out under constraints such as obtaining values in fractions, integers, in a particular range, with a particular mathematical sign (e.g., positive), based on physical constraints etc.

The randomization is subject to one or more mathematical constraint that limits the number of acceptable values of the variable depending on the question type. For example, in a question related to calculation of ages, an age variable can only take values within age range of a typical human being with relative constraints like a father's age relative to a son's age. In a question related to geometrical problems, a physical dimension can lie only in an acceptable range with one or more numerical constraints so as to obtain answers in whole number. Other problems where there may be constraints may be related to calculation of averages (e.g., average weight, average score etc), calculation of a circle area (e.g., diameter/radius is constrained in a way that the pi in the area of circle formula cancels out with a denominator so as to generate an answer in whole number).

The techniques provided by the embodiments herein may be implemented on an integrated circuit chip (not shown). The chip design is created in a graphical computer programming language, and stored in a computer storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly. The stored design is then converted into the appropriate format (e.g., GDSII) for the fabrication of photolithographic masks, which typically include multiple copies of the chip design in question that are to be formed on a wafer. The photolithographic masks are utilized to define areas of the wafer (and/or the layers thereon) to be etched or otherwise processed.

The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections). In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

The embodiments herein can comprise hardware and software elements. The embodiments that are implemented in software include but are not limited to, firmware, resident software, microcode, etc. The functions performed by various modules described herein may be implemented in other modules or combinations of other modules. Furthermore, the embodiments herein can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

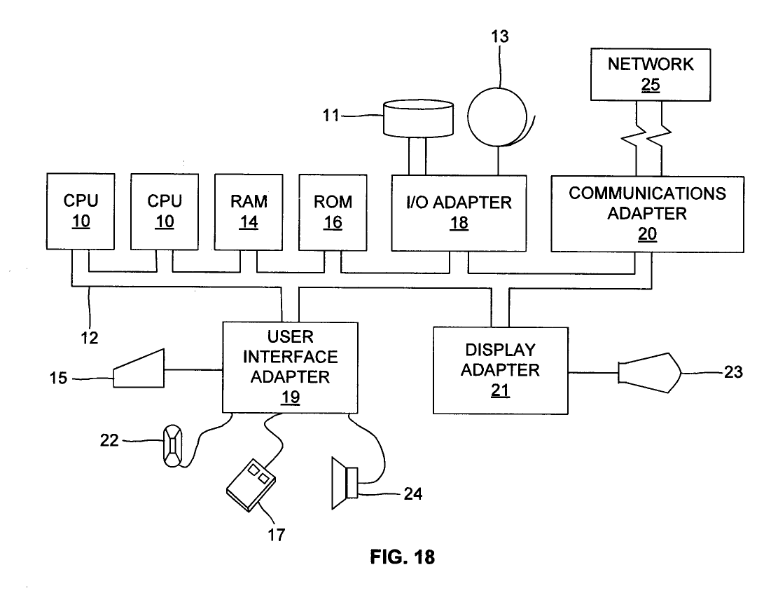

A representative hardware environment for practicing the embodiments herein is depicted in FIG. 18. This schematic drawing illustrates a hardware configuration of an information handling/computer system in accordance with the embodiments herein. The system comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments herein.

The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modifications.

We claim:

1. A customizable electronic system for education comprising:
a processor to process an audio, and a video;
a memory to store a personal information and a performance data of at least one user;
a video formatting chip that formats the video output from said processor;
an audio formatting chip that formats the audio output from said processor;
wherein said processor executes an educational method comprising:
processing a login information corresponding to said user;
displaying a list of options that includes taking a session;
executing at least one session based on a user input that includes selecting said option of taking said session, wherein said session includes at least one question that is displayed on a question screen;
processing a first answer to said at least one question on said question screen;
generating any of an audio or a visual feedback automatically on submitting said answer based on an accuracy of said answer; and
processing at least one additional answer attempted to said question if said first answer is determined to be incorrect.

2. The system of claim 1, wherein said list of options further comprises a practice with an automatic selection, a practice with a user selection, or a review or a rework of said session, wherein said educational method further comprises displaying a progress report based on a performance of said user on a plurality of said sessions.

3. The system of claim 2, wherein said review enables said user to review a previously taken session, and said rework enables the user to redo said session with either same or different values of at least one variable in said question, wherein a correct answer of said question is dependent on a value of said variable.

4. The system of claim 1, wherein said educational method further comprises:
displaying a correct answer adjacent to said answer that is submitted when said answer does not correspond to a correct answer;
customizing said session based on said performance of said user; and
enabling said user to attempt higher level questions once said performance of said user is determined to be consistent.

5. A customizable electronic learning system comprising:
a user database that includes any of a past session information, a personal information and a performance information;
a curriculum database that includes a hierarchical set of questions corresponding to a course, a syllabus, or an examination;
a level setting module that executes a plurality of sessions based on said curriculum data and a extracts a set of questions from the curriculum database based on performance and level of said user, wherein each of said sessions comprises at least one question that includes at least one variable displayed on a question screen, wherein a correct answer of said question is dependent on a value of said variable; and
a randomization module that randomizes values of said variable at different instances of said sessions being executed.

6. The customizable electronic learning system of claim 5, wherein said randomization is subject to at least one mathematical constraint that limits the number of acceptable values of said variable.

7. The customisable electronic system of claim 5 further comprising:
a feedback module that generates an audio or a visual feedback based on a performance of said user in said session; wherein said audio or said visual feedback comprises any of an image corresponding to a likes of said user, a stars, a medals, a congratulatory sound, and a music; and
a topic selection module that allows said user to select a set of topics;
wherein said topic selection module further comprises a session type selector and a list of permitted topics.

8. The customisable electronic system of claim 7 wherein said session type selector enables said user to select a session type that comprises any of:
an automatically generated topic-set from which said user selects a set of topics;
a user-selected topic-set;
a session on a chosen set of topics,
a test on a chosen set of topics, said test having a timeout after which said processor disables input to said system.
a rework of earlier performed question sets with either identical or re-randomized numbers; and
a homework session that is a predefined set of randomized questions.

9. The customisable electronic system of claim 5 further comprising:
a hardware constraint module that specifies a plurality of hardware constraints and permits said system to be customized based on hardware constraints;
a user preference module that allows said user to choose a curriculum based plurality of questions, to set a duration, settings and level based on output by said consistency module; and
a customization module that customizes said system based on said user's personal information stored in said user database.

10. The customisable electronic system of claim 5 further comprising a consistency module that measures a consistency with which said user performs in said session; wherein said consistency is measured on a performance history and a plurality of said sessions attempted and a duration required by said user to attempt said sessions.

11. The customisable electronic system of claim 5 further comprising:
a customization module that enables customization of said question screen based on said personal information;
a curriculum creation module that extracts a subset of said curriculum that is relevant for a particular career and creates a curriculum that is sufficient prerequisite to pursue said career;
a question template selection module that selects question templates from said curriculum database, wherein said question templates are selected based on a level appropriate for said user which is based on feedback from said level-setting module; and
a question creation module that integrates a plurality of questions selected by said question-template selection module with a randomization provided by said randomization module and the customization provided by said customization module and generates a composite question with appropriately customized text, numerical values, colors, images and themes.

12. The customisable electronic system of claim 5 further comprises a performance tracking module that communicates short term and long term performance of said user to said feedback module and to said user database.

13. A customizable electronic learning system:
a user database that includes at least one of any of a personal information, a performance information or a past session information of at least one user;
a curriculum database that includes a hierarchical curriculum data corresponding to a course or a syllabus;
a consistency module that measure a consistency with which said user performs in at least one session; wherein said consistency is measured on a performance history, a plurality of said sessions attempted and a duration required by said user to attempt said sessions; and
a customization module that enables customization of a question screen based on said personal information, wherein said customization includes any of a personalization of at least one question in said session and a personalization of a background of said question screen.

14. The customisable electronic system of claim 13 further comprises a feedback module that generates an audio or video feedback on a performance of said user in said session.

15. The customisable electronic system of claim 13 wherein said personal information includes any of a name, a gender, an age, a likes, a dislikes, a friends, or an enemies, wherein said question is a word problem and said personalization of said question includes a question theme based on said personal information, and wherein said personalization of said background includes a personalized images or a personalized multimedia.

16. The customisable electronic system of claim 13 further comprises:
a performance tracking module that communicates short term and long term performance of said user to said feedback module and to said user database; and
an answer evaluation module that evaluates answers of said user based on constrained randomization in said questions and renders correct answer adjacent to said answer of said user in case said answer is incorrect.

17. A customizable electronic learning system comprising:
a user database that includes at least one of any of a personal information, a performance information or a past session information of at least one user;
a curriculum database that includes a hierarchical curriculum data corresponding to a course, a syllabus or an exam;
a customization module that enables customization of a question screen based on said personal information, wherein said customization includes any of a personalization of at least one question in said session and a personalization of a background of said question screen, wherein said personal information includes any of a name, a gender, an age, a likes, a dislikes, a friends, or an enemies, wherein said personalization of said background includes a personalized images or a personalized multimedia; and
a hardware constraints module that specifies hardware constraints and allows said system to be customised based on hardware constraints.

18. The customizable electronic learning system of claim 17 further comprising a randomization module that randomizes values of said variables at different instances of said sessions being executed.

19. A customizable electronic learning system comprising:
a user database that includes at least one of any of a personal information, a performance information or a past session information of at least one user;
a curriculum database that includes a hierarchical curriculum data corresponding to a course, an exam, or a syllabus;
a question creation module that integrates a plurality of questions selected by said question-template selection module with a randomization and a customization and generates a composite question with appropriately customized text, numerical values, colors, images and themes;
performance tracking module that tracks a plurality of session attempted, score and a duration required; and
a feedback module that generates an audio or image feedback based on a performance of said user in said session; wherein said audio or image feedback comprises stars, medals and music.

20. The customizable electronic learning system of claim 19 further comprising a curriculum creation module that extracts a subset of said curriculum that is relevant to a particular career and creates a curriculum that is a prerequisite to pursue said career.
